(19) United States
(12) Patent Application Publication
(10) Pub. No.: US 2026/0256120 A1
(43) Pub. Date: Sep. 3, 2026

(54) Wild Bird Feeder Device

(71) Applicant: John Peterson, Canton, SD (US)

(72) Inventor: John Peterson, Canton, SD (US)

(21) Appl. No.: 19/066,961

(22) Filed: Feb. 28, 2025

(51) Int. Cl. A01K 39/012

(52) U.S. Cl. CPC A01K 39/012

(57) ABSTRACT

A wild bird feeder device for feeding wild birds includes wild bird feed and a feeder having an interior space for holding the wild bird feed. The feeder includes a base and a perimeter wall defining an interior space. A front face of the perimeter wall is formed by a plurality of front slats. The front slats are parallel and spaced to define front gaps between adjacently positioned front slats. The front gaps are sized such that the wild bird feed is inhibited from passing through the front gaps and is retained within the interior space. Each of the front gaps allows a wild bird to peck and scratch the wild bird feed from the interior space through the front gap between adjacently positioned front slats.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wild bird feeder devices and more particularly pertains to a new wild bird feeder device for feeding wild birds by allowing access to feed, crushed shells, and grit pecked or scratched through gaps in a face of a feeder.

### (2) Description of Related Art Including Information Disclosed Under 37 CFR 1.97 and 1.98

The prior art relates to wild bird feeder devices. Known devices lack access to feed through gaps sized to require pecking or scratching to draw feed, crushed shells, and grit from a storage area of the feeder.

### BRIEF SUMMARY OF THE INVENTION

An embodiment of the disclosure meets the needs presented above by generally comprising wild bird feed and a feeder having an interior space for holding the wild bird feed. The feeder includes a base and a perimeter wall defining an interior space. A front face of the perimeter wall is formed by a plurality of front slats. The front slats are parallel and spaced to define front gaps between adjacently positioned front slats. The front gaps are sized such that the wild bird feed is inhibited from passing through the front gaps and is retained within the interior space. Each of the front gaps allows a wild bird to peck and scratch the wild bird feed from the interior space through the front gap between adjacently positioned front slats.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a wild bird feeder device according to an embodiment of the disclosure.

FIG. 2 is a top front side perspective view of an embodiment of the disclosure in an open position.

FIG. 3 is a bottom view of an embodiment of the disclosure.

FIG. 4 is a side view of an embodiment of the disclosure.

FIG. 5 is a back view of an embodiment of the disclosure.

FIG. 6 is a front view of an embodiment of the disclosure in use.

FIG. 7 is a front view of an alternative embodiment of the disclosure.

FIG. 8 is a top front side perspective view of an alternative embodiment of the disclosure.

### DETAILED DESCRIPTION OF THE INVENTION

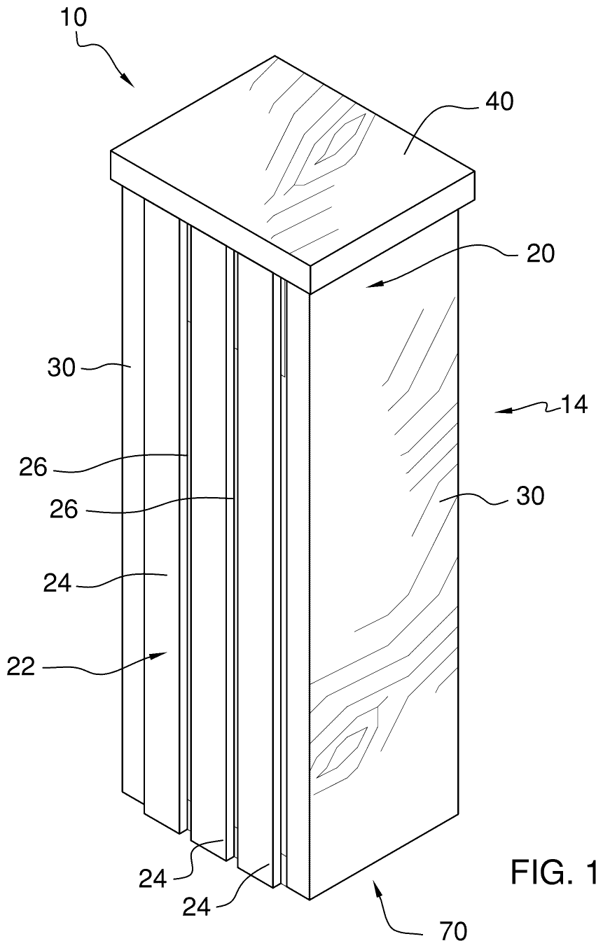

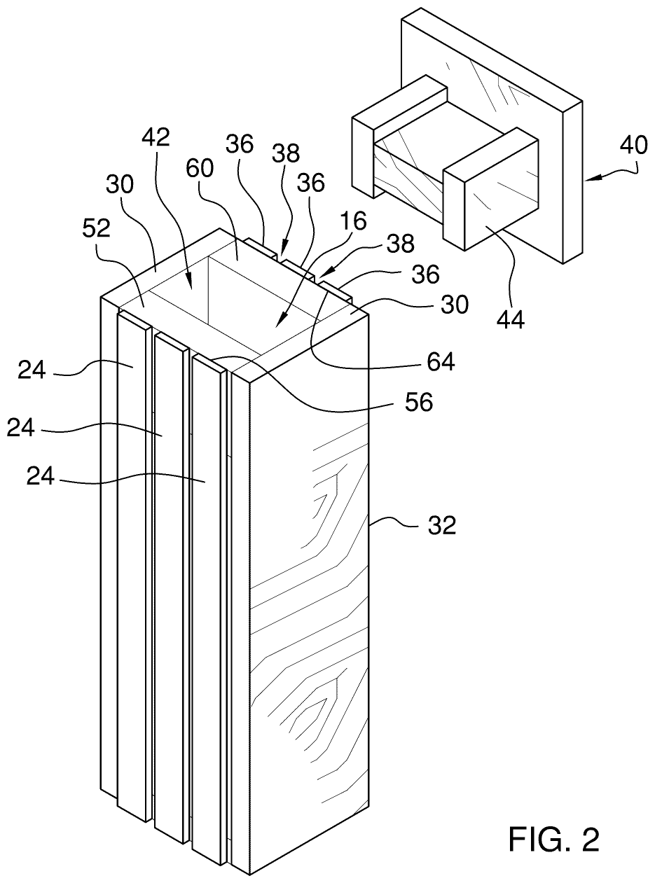

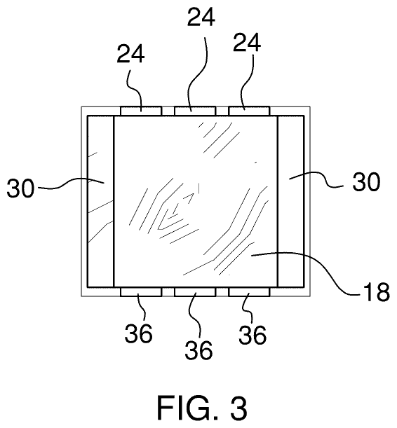

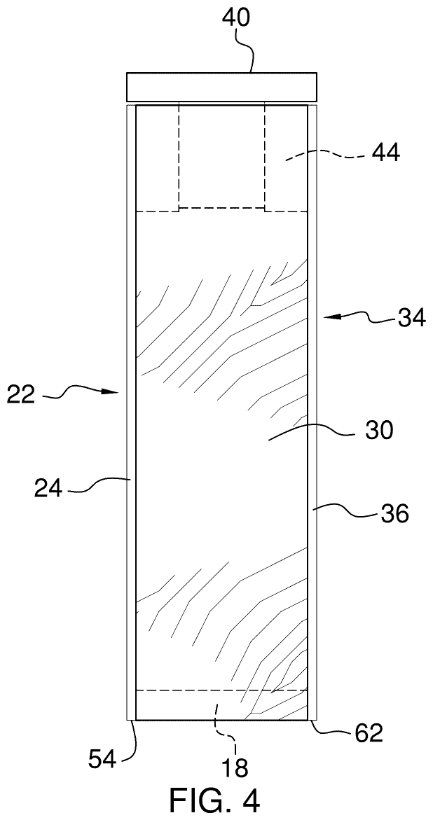

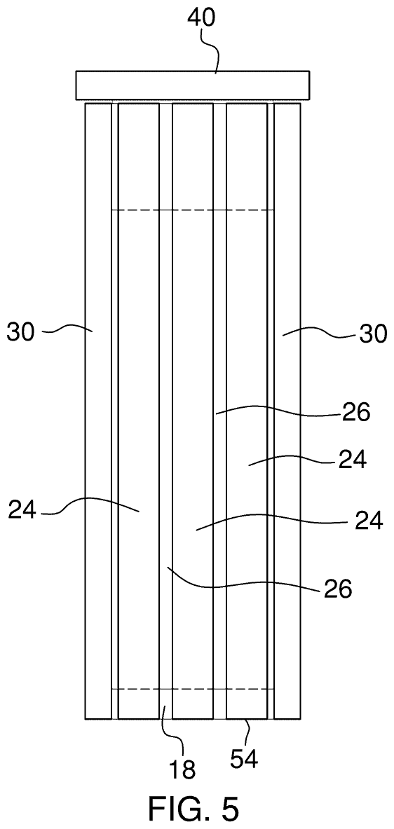

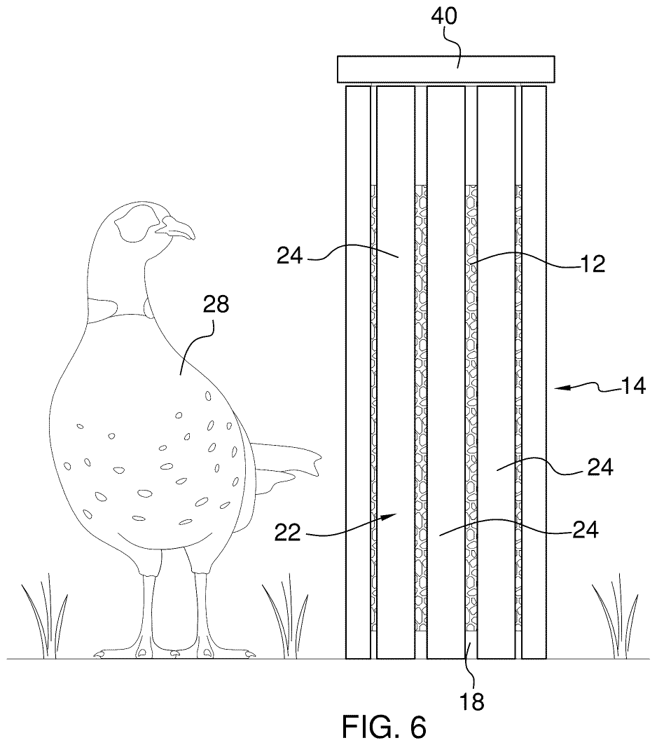

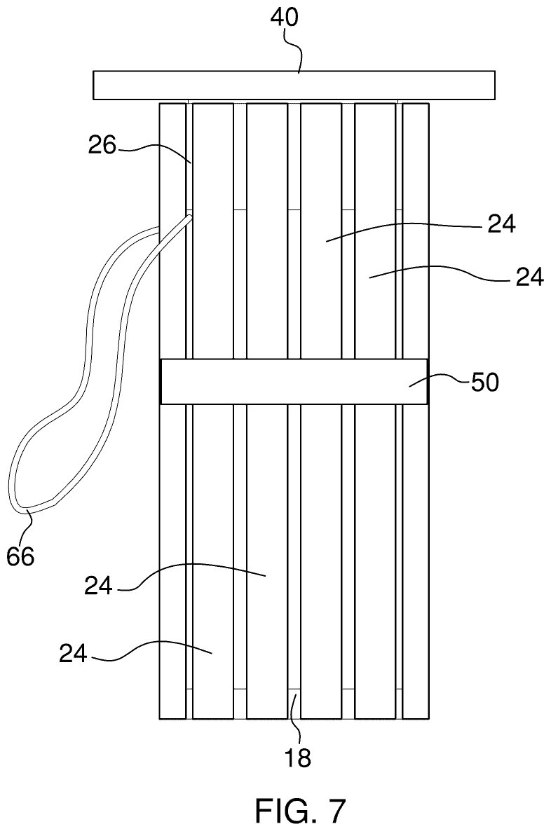

With reference now to the drawings, and in particular to FIGS. 1 through 8 thereof, a new wild bird feeder device embodying the principles and concepts of an embodiment of the disclosure and generally designated by the reference numeral 10 will be described.

As best illustrated in FIGS. 1 through 8, the wild bird feeder device 10 generally comprises wild bird feed 12. The wild bird feed 12 may include seeds with or without shells, or any conventional bird feed. The wild bird feed 12 may further include grit elements such as small rocks, or other conventional elements known to be beneficial for digestion when consumed by birds. Additionally, crushed shells may be incorporated into the wild bird feed 12 to enhance calcium uptake. Generally, the wild bird feed will have some consistency in the size of the separate pieces within the wild bird feed consistent with the relationship to the feeder as described further below.

A feeder 14 has an interior space 16 for holding the wild bird feed 12. The feeder includes a base 18. The base 18 may be a wood panel or the like. A perimeter wall 20 is coupled to and extends upwardly from the base 18 to define the interior space 16. The perimeter wall 20 has a front face 22. The front face 22 is formed by a plurality of front slats 24. The front slats 24 are parallel and spaced to define a plurality of front gaps 26 in the front face 22 between adjacently positioned front slats 24. The front gaps 26 between the adjacently positioned front slats 24 are sized such that the wild bird feed 12 is inhibited, but not necessarily completely prevented, from passing through the front gaps 26 between the adjacently positioned front slats 24 and is retained within the interior space 16. Each of the front gaps 26 is further configured for allowing a wild bird 28 to peck and/or scratch the wild bird feed 12 from the interior space 16 through the front gap 26 between adjacently positioned front slats 24. The perimeter wall 20 has a pair of lateral sides 30. Each lateral side 30 is continuous within a peripheral edge 32 of the lateral side 30 such that no wild bird feed 12 can pass through the lateral sides 30. The perimeter wall 20 has a back face 34. The back face 34 is formed by a plurality of back slats 36. The back slats 36 are parallel and spaced to define a plurality of back gaps 38 in the back face 34 between adjacently positioned back slats 36 in the same manner as the formation of the front gaps 26. The back gaps 38 between the adjacently positioned back slats 36 are sized such that the wild bird feed 12 is inhibited, but not necessarily completely prevented, from passing through the back gaps 38 between the adjacently positioned back slats 36 and is retained within the interior space 16. Each of the back gaps 38 is further configured for allowing the wild bird 28 to peck and/or scratch the wild bird feed 12 from the interior space 16 through the back gap 38 between adjacently positioned back slats 36. A lid 40 is positionable to cover an open top 42 of the feeder 14. The lid 40 may have an insert block 44 sized to fit within the open top 42 to frictionally secure the lid 40 to the perimeter wall 20. Additionally, a hole 72 may be extended through one of the lateral sides 30 and aligned with an aperture 74 in the insert block 44 when the lid 40 is on the feeder 14. A pin 76 can be inserted into the hole 72 and the aperture 74 to further secure the lid 40 to the feeder 14.

The feeder 14 may be constructed in various sizes and the plurality of front slats 24 may be between 2 and 5 front slats 24. The plurality of back slats 36 may be a number of back slats 36 equal to a number of front slats 24 producing symmetry between the front and back of the feeder 14. It is further contemplated that wider feeders could employ additional front slats 24 as desired. The feeder may have only a single face with the described gap structure, or all four faces, or even more faces with the described gap structure if constructed in polygonal shapes having more than four sides. When the number of front slats 24 is four front slats 24, a front medial brace slat 50 may be coupled to the front slats 24. The front medial brace slat 50 is perpendicular to the front slats 24. The front medial brace slat 50 is positioned proximate a middle of each of the front slats 24. The front medial brace slat 50 is shown on one size of the feeder 14 having four front slats 24, but it is contemplated as being within the ordinary skill to incorporate such a front medial brace slat 50 for feeders having varied numbers of front slats 24. The front medial brace slat 50 provides structural rigidity and helps to maintain consistent spacing of the front gaps 26. The front face 22 has a front top brace 52. Each of the front slats 24 is coupled to the front top brace 52. A bottom end 54 of each of the front slats 24 is coupled to the base 18 although a front bottom brace could be provided for connecting the bottom end 54 of each front slat 24. The front top brace 52 is positioned abutting an interior side 56 of each of the front slats 24 so that the front slats 24 extend a full length of the front face 22. Similarly, the back face 34 has a back top brace 60. Each of the back slats 36 is coupled to the back top brace 60. A bottom end 62 of each of the back slats 36 is coupled to the base 18. The back top brace 60 is positioned abutting an inner side 64 of the back slats 36. A cord 66 can threaded through one of the front gaps 26 and one of the back gaps 38 such that the cord 66 is configured for hanging or tying the feeder 14 to a branch, post, fence, a mounting hook or the like if desired.

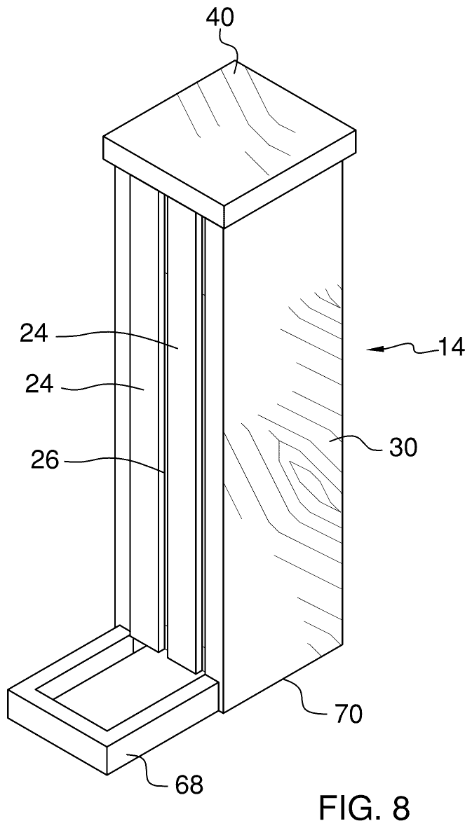

A tray 68 may be coupled to the feeder 14. The tray 68 is positioned at a bottom 70 of the feeder 14 and extends forwardly from the front face 22. Although shown only in FIG. 8 with a feeder 14 having only two front slats 24, it is contemplated that the tray 68 is a variation which could be provided, particularly with smaller feeders. It is further contemplated that a tray 68 could also be extended to the back either as a separate tray or as a continuous tray having sufficient length to extend both forwardly and rearwardly. For larger feeders a base extension 78 may be provided. Holes 80 extend through the base extension 78 to allow for stakes 82 of the like to secure the base extension 78 to the ground.

In use, the feeder 14 is positioned as desired, such as away from a public roadway so as to provide sustenance to wild game birds during winter without drawing them near to public traffic. Further, the feeder 14 may be positioned in generally close proximity to a winter roost, nest, or natural habitat to allow wild birds to reduce stress of having to find feed far from the roost or nest. The spacing of the front gaps 36 and back gaps 38 inhibits spillage of the wild bird feed 12 for greater efficiency and to prevent other animals from accessing or quickly consuming the wild bird feed if they cannot peck or scratch the wild bird feed 12 from the feeder 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wild bird feeder device comprising:
wild bird feed;
a feeder having an interior space for holding said wild bird feed, said feeder including:
a base;
a perimeter wall coupled to and extending upwardly from said base to define said interior space, said perimeter wall having a front face, said front face being formed by a plurality of front slats, said front slats being parallel and spaced to define a plurality of front gaps in said front face between adjacently positioned front slats, said front gaps between said adjacently positioned front slats being sized such that said wild bird feed is inhibited by a size of the wild bird feed from passing through said front gaps between said adjacently positioned front slats and is retained within said interior space, each of said front gaps being further configured for allowing a wild bird to peck and scratch said wild bird feed from said interior space through said front gap between the adjacently positioned front slats.

2. The wild bird feeder device of claim 1, further comprising a lid, said lid being positionable to cover an open top of said feeder.

3. The wild bird feeder device of claim 1, further comprising said perimeter wall having a pair of lateral sides, each lateral side being continuous within a peripheral edge of said lateral side.

4. The wild bird feeder device of claim 1, further comprising said perimeter wall having a back face, said back face being formed by a plurality of back slats, said back slats being parallel and spaced to define a plurality of back gaps in said back face between adjacently positioned back slats, said back gaps between said adjacently positioned back slats being sized such that said wild bird feed is inhibited from passing through said back gaps between said adjacently positioned back slats and is retained within said interior space, each of said back gaps being further configured for allowing a wild bird to peck and scratch said wild bird feed from said interior space through said back gap between the adjacently positioned back slats.

5. The wild bird feeder device of claim 1, further comprising said plurality of front slats being between two and five front slats.

6. The wild bird feeder device of claim 4, further comprising said plurality of back slats being a number of the back slats equal to a number of the front slats.

7. The wild bird feeder device of claim 1, further comprising:
said number of front slats being four front slats; and
a front medial brace slat coupled to said front slats, said front medial brace slat being perpendicular to said front slats, said front medial brace slat being positioned proximate a middle of each of said front slats.

8. The wild bird feeder device of claim 1, further comprising said front face having a front top brace, each of said front slats being coupled to said front top brace, a bottom end of each of said front slats being coupled to said base.

9. The wild bird feeder device of claim 8, further comprising said front top brace being positioned abutting an interior side of each of said front slats.

10. The wild bird feeder device of claim 4, further comprising said back face having a back top brace, each of said back slats being coupled to said back top brace, a bottom end of each of said back slats being coupled to said base.

11. The wild bird feeder device of claim 10, further comprising said back top brace being positioned abutting an inner side of said back slats.

12. The wild bird feeder device of claim 4, further comprising a cord, said cord being threaded through one of said front gaps and one of said back gaps wherein said cord is configured for hanging said feeder.

13. The wild bird feeder device of claim 1, further comprising a tray coupled to said feeder, said tray being positioned at a bottom of said feeder, said tray extending forwardly from said front face.

14. A wild bird feeder device comprising:
wild bird feed;
a feeder having an interior space for holding said wild bird feed, said feeder including:
a base;
a perimeter wall coupled to and extending upwardly from said base to define said interior space, said perimeter wall having a front face, said front face being formed by a plurality of front slats, said front slats being parallel and spaced to define a plurality of front gaps in said front face between adjacently positioned front slats, said front gaps between said adjacently positioned front slats being sized such that said wild bird feed is inhibited from passing through said front gaps between said adjacently positioned front slats by a size of the wild bird feed and is retained within said interior space, each of said front gaps being further configured for allowing a wild bird to peck and scratch said wild bird feed from said interior space through said front gap between the adjacently positioned front slats, said perimeter wall having a pair of lateral sides, each lateral side being continuous within a peripheral edge of said lateral side, said perimeter wall having a back face, said back face being formed by a plurality of back slats, said back slats being parallel and spaced to define a plurality of back gaps in said back face between adjacently positioned back slats, said back gaps between said adjacently positioned back slats being sized such that said wild bird feed is inhibited from passing through said back gaps between said adjacently positioned back slats and is retained within said interior space, each of said back gaps being further configured for allowing a wild bird to peck and scratch said wild bird feed from said interior space through said back gap between the adjacently positioned back slats, and
a lid, said lid being positionable to cover an open top of said feeder.

15. The wild bird feeder device of claim 14, further comprising said plurality of front slats being between two and five front slats, said plurality of back slats being a number of the back slats equal to a number of the front slats.

16. The wild bird feeder device of claim 14, further comprising:
said number of front slats being four front slats;
a front medial brace slat coupled to said front slats, said front medial brace slat being perpendicular to said front slats, said front medial brace slat being positioned proximate a middle of each of said front slats;
said front face having a front top brace, each of said front slats being coupled to said front top brace, a bottom end of each of said front slats being coupled to said base, said front top brace being positioned abutting an interior side of each of said front slats;
said back face having a back top brace, each of said back slats being coupled to said back top brace, a bottom end of each of said back slats being coupled to said base, said back top brace being positioned abutting an inner side of said back slats; and
a cord, said cord being threaded through one of said front gaps and one of said back gaps wherein said cord is configured for hanging said feeder.

17. The wild bird feeder device of claim 14, further comprising a tray coupled to said feeder, said tray being positioned at a bottom of said feeder, said tray extending forwardly from said front face.
